(19) United States
(12) Patent Application Publication
(10) Pub. No.: US 2026/0007953 A1
(43) Pub. Date: Jan. 8, 2026

(54) VIDEO GAME CONTROLLER

(71) Applicant: Avetos Design LLC, Logan, UT (US)

(72) Inventor: Sean Mahnken, Logan, UT (US)

(21) Appl. No.: 19/007,384

(22) Filed: Dec. 31, 2024

Related U.S. Application Data
(60) Provisional application No. 63/668,097, filed on Jul. 5, 2024.

(51) Int. Cl. A63F 13/24; A63F 13/21

(52) U.S. Cl. CPC A63F 13/24; A63F 13/21

(57) ABSTRACT

Systems and techniques are described herein for a human-machine interface. For instance, an apparatus for a human-machine interface is provided. The apparatus may include a body and a joystick coupled to the body, the joystick comprising: a spiral spring configured to bias the joystick to a neutral position; a detectable component coupled to the spiral spring; and a sensor configured to detect a position of the detectable component.

### CROSS-REFERENCE TO RELATED APPLICATIONS

This application claims the benefit of U.S. Provisional Application No. 63/668,097, titled APPARATUS A VIDEO GAME CONTROLLER, filed Jul. 5, 2024, which is incorporated herein by reference in its entirety.

### TECHNICAL FIELD

The present disclosure generally relates to a human-machine interface. For example, aspects of the present disclosure include systems and techniques for a human-machine interface.

### BACKGROUND

The gaming industry has seen rapid advancements in technology over the years, leading to the development of various gaming consoles and platforms. This has led to an increase in the demand for versatile gaming controllers that can be used under varied conditions and across multiple gaming platforms.

### SUMMARY

Systems, apparatuses, methods (also referred to as processes), and computer-readable media (collectively referred to herein as “systems and techniques”) are described herein for a human-machine interface, the apparatus including: a body and a joystick attached to the body, the joystick including: a spiral spring configured to bias the joystick to a neutral position; a detectable component coupled to the spiral spring; and a sensor configured to detect a position of the detectable component.

In some aspects, the systems and techniques described herein relate to an apparatus for a human-machine interface, the apparatus including: a body and a joystick attached to the body, the joystick including: a spiral spring configured to bias the joystick to a neutral position; a detectable component coupled to the spiral spring; and a sensor configured to detect a position of the detectable component.

In some aspects, the systems and techniques described herein relate to an apparatus,
wherein the joystick includes a pad to be manipulated by a user, wherein the pad is coupled to the spiral spring.

In some aspects, the systems and techniques described herein relate to an apparatus,
wherein the joystick has a thickness less than 10 millimeters.

In some aspects, the systems and techniques described herein relate to an apparatus,
wherein a topmost surface of the joystick is substantially flush with a topmost surface of the body.

In some aspects, the systems and techniques described herein relate to an apparatus,
wherein a top-most surface of the joystick extends above a topmost surface of the body by 2.5 millimeters or less.

In some aspects, the systems and techniques described herein relate to an apparatus,
wherein the spiral spring is configured to rotate within the body relative to an axis of winding of the spiral spring.

In some aspects, the systems and techniques described herein relate to an apparatus,
wherein the spiral spring includes a multi-start spiral spring.

In some aspects, the systems and techniques described herein relate to an apparatus,
wherein the spiral spring has a thickness of less than 5 millimeters (mm).

In some aspects, the systems and techniques described herein relate to an apparatus,
wherein the spiral spring has an outer diameter of greater than 10 millimeters (mm) and less than 45 mm.

In some aspects, the systems and techniques described herein relate to an apparatus,
wherein the detectable component includes a magnet; and the sensor includes a magnetic field (or Hall effect) sensor.

In some aspects, the systems and techniques described herein relate to an apparatus,
wherein the detectable component includes a conductive element; and the sensor includes an inductive or a capacitive sensor.

In some aspects, the systems and techniques described herein relate to an apparatus,
wherein the spiral spring is configured to be replaceable.

In some aspects, the systems and techniques described herein relate to an apparatus,
wherein the body has a substantially uniform thickness.

In some aspects, the systems and techniques described herein relate to an apparatus,
wherein the apparatus has a thickness of 10 millimeters or less.

In some aspects, the systems and techniques described herein relate to an apparatus,
wherein the body is sized to be held in a hand of a user with a thumb on the joystick.

In some aspects, the systems and techniques described herein relate to an apparatus,
wherein the body has a width of 125 millimeters or less and a height of 75 millimeters or less.

In some aspects, the systems and techniques described herein relate to an apparatus,
wherein the body includes a retention mechanism for attaching the apparatus to a mobile device or to a case of mobile device.

In some aspects, the systems and techniques described herein relate to an apparatus,
wherein the sensor is configured to generate a signal indicative of the position of the detectable component, the apparatus further including a wireless communication module configured to send the signal to an external electronic device.

In some aspects, the systems and techniques described herein relate to an apparatus including: a mobile-device case including a controller-retention mechanism; and a controller including a retaining mechanism about at least a portion of a perimeter of the controller, the retaining mechanism operable to fit within the controller-retention mechanism, wherein the retaining mechanism may be operable to detachably couple with the controller-retention mechanism, wherein the controller-retention mechanism includes a tongue and wherein the retaining mechanism includes a groove.

In some aspects, the systems and techniques described herein relate to a system including: an electronic device; and a controller configured to provide signals to the electronic device; the controller including: a body and a joystick attached to the body, the joystick including: a spiral spring configured to bias the joystick to a neutral position; a detectable component coupled to the spiral spring; and a sensor configured to detect a position of the detectable component.

In some aspects, the systems and techniques may be operable to provide a full-featured video game controller with a compact profile, small enough to fit within a user's pocket, and capable of detachably coupling to a user's mobile device.

In some aspects, the systems and techniques may facilitate wireless communication between the portable video game controller and an external electronic device, such as a gaming system, enhancing the user's gaming experience.

In some aspects, the systems and techniques may provide a mobile device case that can be operably attached to the video game controller, offering a convenient and portable gaming solution.

In some aspects, the systems and techniques may equip the portable video game controller with various inputs, including a joystick, buttons, triggers, a directional pad, and a touch surface, to provide a comprehensive gaming control interface.

In some aspects, the systems and techniques may include a portable video game controller comprising a body with a front cover and a back cover, housing a circuit board. The controller input may be coupled with the circuit board, along with a power supply. A wireless charging module may be coupled to the power supply, and a wireless communications module may be coupled with the circuit board, enabling communication with an external electronic device. The controller body features a retention mechanism that can detachably couple with a mobile device.

In some aspects, the controller input may comprise a joystick with a detectable component operably coupled with a biasing member. The joystick may further comprise at least one sensor opposite the detectable component, capable of capturing an input to the joystick from a user.

In another aspect, the biasing member of the joystick may be a planar spiral spring, and the detectable component may be a magnet suspended within the spiral spring.

In some aspects, the controller input may also comprise at least one button, at least one trigger, at least one directional pad, and at least one touch surface. The wireless communications module may include Bluetooth or near-field communication.

In some aspects, the controller body may have a uniform thickness, possibly below 1.0 cm, making it compact and portable.

In some aspects, the systems and techniques may include a portable game controller system comprises a mobile device with a game-controller retention mechanism and a game controller with a retaining mechanism around a portion of its perimeter. The retaining mechanism can fit within the device retaining mechanism and may be operable to detachably couple with the game-controller retention mechanism.

In some aspects, the mobile device may comprise a mobile device case, with the game-controller retention mechanism coupled with the mobile device case. The game-controller retention mechanism may comprise at least one tongue, and the retaining mechanism may comprise at least one corresponding groove.

In some aspects, the systems and techniques may include a mobile device case comprises a sleeve operable to fit about a mobile device. The sleeve may comprise a game-controller retention mechanism coupled with the sleeve, operable to fit about a portable game controller. The game-controller retention mechanism may comprise at least one tongue operate to fit with a corresponding groove on an external game controller.

In some aspects, the systems and techniques provide a convenient and portable gaming solution, enhancing the user's gaming experience with its comprehensive control interface and the ability to detachably couple with a mobile device. The compact design of the controller makes it easy to carry, while its ability to communicate wirelessly with an external electronic device provides flexibility and ease of use.

Aspects of the present disclosure are described with regard to gaming and a gaming system as an example. Aspects of the present disclosure relate more generally to human-machine interfaces. For example, a controller or game controller as described herein may be used to interface with electronic devices whether the electronic devices involve a game or not. For example, a user may interact with a phone, tablet, or personal computer for purposes other than gaming using the controller described herein. For example, the controller and joystick described herein can be used in place of mouse or touch screen to interface with an electronic device.

The foregoing paragraphs have been provided by way of general introduction and are not intended to limit the scope of the following claims. The described embodiments, together with further advantages, may be understood by reference to the following detailed description taken in conjunction with the accompanying drawings.

### BRIEF DESCRIPTION OF THE FIGURES

FIG. 1: A front view of a portable video game controller is illustrated.

FIG. 2: A perspective view of the portable video game controller is illustrated.

FIG. 3: A perspective view of a retainer, which may be operable to couple with the portable video game controller is illustrated.

FIG. 4: A front view of the retainer, which can be coupled with the portable video game controller, is presented with dimensions.

FIG. 5: An exploded view of the video game controller is depicted.

FIG. 6: A block diagram illustrating the use of the portable video game controller may be shown.

FIG. 7: A method for portable gaming, illustrating the steps of attaching the portable video game controller to the mobile device case, connecting the controller to a gaming system, and controlling the gaming system using the controller, is demonstrated.

FIG. 8: A perspective view of the front and back of a planar spiral spring is illustrated.

FIG. 9: A cutaway detail view of a planar spiral spring is illustrated.

FIG. 10: An exploded view of a joystick using a planar spiral spring with a detectable component is illustrated.

FIG. 11: A cutaway detail view of an assembled game controller using a spiral spring and detectable component is illustrated.

FIG. 12: Dimensions for the portable video game controller are illustrated.

FIG. 13: An example cellular phone case with integrated video game controller retainer is illustrated.

FIG. 14: A depiction of the portable video game controller as it is held by a user is shown.

TERMS

In the present disclosure the term “spiral spring” may refer to any spring wherein actuation of the spring occurs orthogonal to the axis of winding. Spiral springs may be flat (e.g., wound around a winding axis in a plane). These types of springs are sometimes referred to as “clock springs” or “torsional springs”, though these names imply a rotational energy storage mechanism that is not germane to the present disclosure. Pertinent to the present disclosure is the translational biasing aspects of the spring. Such springs store energy as they are actuated laterally (i.e., translated within the plane of the spring), enabling them to bias an inner winding laterally toward a neutral position. In the present disclosure the term “planar spiral spring” is synonymous with the term “spiral spring.”

In the present disclosure, the term “neutral position”, when used in the context of a spiral spring or joystick, refers to a position in which the spiral spring exerts a net zero force on at least a portion of the spiral spring (e.g., an innermost winding of the spiral spring). From the neutral position, wherein the device may measure and/or report that no displacement is presently occurring.

In the present disclosure, the term “bias,” when used as a verb with reference to a spiral spring, may refer to the spiral spring exerting a force to return at least a portion of the spring (e.g., an innermost winding of the spiral spring), to a neutral position. For example, if an innermost winding of a central spring is displaced laterally from its neutral position, the spiral spring may exert a force to return the innermost winding spring to the neutral position.

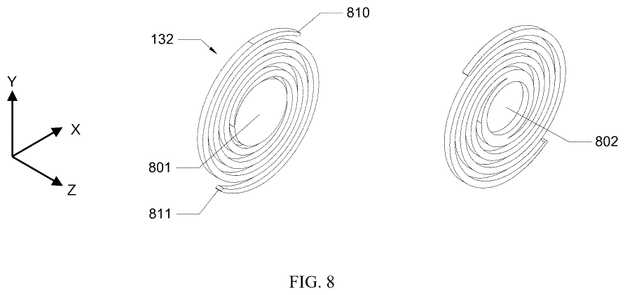

In the present disclosure, the term “multi-start” is an adjective describing a spiral spring that contains more than one wire or spline in its winding. The number of splines in the winding of a spiral spring can be determined by counting the “ends” of the spring around the outer perimeter of the same. (see FIG. 8). For example, the terms “two-start” and “three-start” describe spiral springs with two or three (respective) splines.

In the present disclosure the term “body” may refer to the overall mechanical assembly of the game controller.

In the present disclosure the term “core” may refer to the central support apparatus upon which and by which other components are attached and situated within the device.

In the present disclosure, the term “pad”, when used in the context of the joystick, describes the domed or shaped top on the central body of the spiral spring.

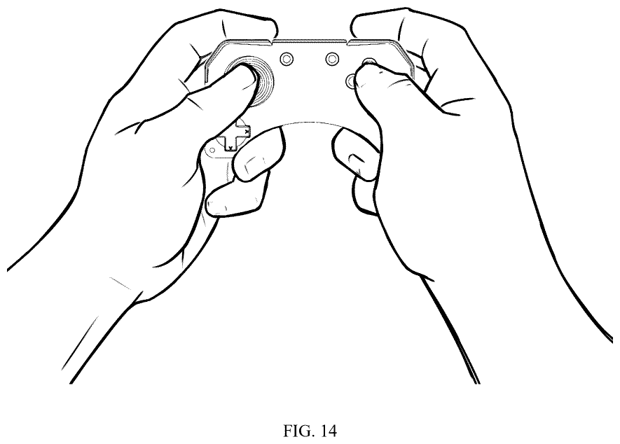

In the present disclosure, the term “width” describes the horizontal dimension across the front of the device from left to right when held in the traditional manner (see FIG. 14).

In the present disclosure, the term “height” describes the vertical dimension across the front of the device from bottom to top when held in the traditional manner (see FIG. 14).

In the present disclosure, the term “thickness” describes the dimension through the device from back to front, and is synonymous with the term “depth”.

In the present disclosure, the term “mobile device” may refer to a cellular phone, tablet, laptop computer, gaming system, or other electronic device generally considered to be portable.

In the present disclosure, the term “gaming system” may refer to any device capable of running a game. This includes dedicated gaming devices as well as mobile devices with sufficient computational capacity and graphical display capability to enable gameplay on them.

In the present disclosure, the term “human-machine interface” follows the definition from the National Institute for Standards and Technology (NIST), namely: “The hardware or software through which an operator interacts with a [device].” Per NIST SP 800-82r3.

In the present disclosure, the term “capacitive sensor” refers to any sensor designed to detect changes in a static electric field (or e-field) between two conductors.

In the present disclosure, the term “inductive sensor” refers to any sensor or circuit designed to detect changes in the electrical current through an inductor or coil.

In the present disclosure, the term “conductive element” refers to a component that conducts electricity (e.g., a piece of metal).

In the present disclosure, the term “outer diameter,” in the context of a planar spiral spring, refers to the diameter of the smallest circle that may be circumscribed about the spring, wherein the circle lies in the same plane as the intended motion of the spring, and wherein the circle fully encloses the spring.

In the present disclosure, the term “button state” refers to whether a button is depressed or not. Additionally or alternatively, a button may have various positions and a button state may define which position the button is in.

In the present disclosure, the term “end user” describes an individual that uses a game controller to play video games on a mobile device.

In the present disclosure, the term “replaceable” may refer to a component that may be removed and replaced (e.g., with a replacement component). In some aspects, a replaceable component may be replaced by an end user (e.g., a person without specialized skills or tools).

In the present disclosure, the term “attached” with reference to a replaceable component of a controller, may refer to the component being removably affixed to the controller. For example, a joystick may be coupled to a controller, yet a spiral spring and/or pad of the joystick may be replaceable.

### DETAILED DESCRIPTION

The gaming industry has seen rapid advancements in technology over the years, leading to the development of various gaming consoles and platforms. This has led to an increase in the demand for versatile gaming controllers that can be used under varied conditions and across multiple gaming platforms.

However, there are several challenges associated with the current video game controllers. For instance, the lack of portability may be a major issue for many gamers. Many controllers are bulky and not designed for easy transport. This makes it difficult for gamers who wish to carry their controllers for gaming sessions at different locations. Furthermore, many controllers are designed to work with a specific gaming system, limiting their usability across different platforms.

Another problem may be the lack of universal connectivity. Many controllers are not equipped with the ability to connect with multiple gaming systems. This makes it inconvenient for gamers who own multiple gaming systems, as they need to invest in separate controllers for each system. Additionally, the process of connecting controllers to different systems can be complicated and time-consuming.

Attempts to solve these problems have included the development of universal controllers. These controllers are designed with the capability to connect with multiple gaming systems. However, they often lack the portability factor. Some solutions have also included the design of compact controllers. However, these often lack the functionality and case of use offered by larger controllers.

Other attempts have included non-electronic devices that adhere directly to the screen of a mobile device. These types of devices have generally failed in the market due to several problems, including breakage, lack of consistent feel, and potential damage to the screen of the mobile device.

Therefore, there may be a need to overcome the problems discussed above. A video game controller that is highly portable, capable of connecting with multiple gaming systems, and provides a familiar case of use would be an innovative solution in the gaming industry. The development of such a controller would address the issues of portability and universal connectivity, thereby enhancing the overall gaming experience for users.

In some aspects, the systems and techniques may include a video game controller with a compact profile, designed to fit within a user's pocket. This controller may be designed to detachably couple to a user's mobile device case, providing a convenient and portable gaming solution. The controller may be equipped with a wireless communication module, enabling it to connect to a gaming system for seamless gameplay. This innovative design combines portability and functionality, offering a unique solution for mobile gamers.

Aspects of the present disclosure may be understood by reference to the description set forth herein. The aspects described herein will be better appreciated and understood when considered in conjunction with the following descriptions. Let it be understood, however, that the following descriptions, while indicating specific aspects and numerous details thereof, are given by way of illustration only and should not be treated as limitations. Changes and modifications may be made within the description herein without departing from the scope and intent thereof, and the present disclosure herein may comprise any or all such modifications.

The body of the portable video game controller 100 comprises a front cover and a back cover. These components encase a circuit board, which may be the heart of the controller. The circuit board may be responsible for processing inputs from the controller and communicating with the gaming system. The controller's compact design does not compromise its functionality, as it houses a full suite of inputs and components within its small body.

The controller input may be coupled with the circuit board, allowing the user to interact with the gaming system. The input may be a joystick, buttons, or a touch surface, depending on the specific design of the controller. These inputs are designed to be responsive and tactile, offering a satisfying gaming experience.

The controller may be equipped with a power supply, which provides the energy for its operation. This power supply may be coupled with the circuit board, ensuring that the controller remains powered during gameplay. The power supply may be a battery, which can be recharged using a wireless charging module integrated into the controller.

The wireless charging module may be coupled to the power supply, providing a convenient way to recharge the controller. The wireless charging module may use technologies such as Qi wireless charging, enabling the controller to be recharged by simply placing it on a compatible charging pad.

The controller features a wireless communications module, which may be coupled with the circuit board. This module enables the controller to communicate with an external electronic device, such as a gaming console or a mobile device. The communications module may use technologies such as Bluetooth or other wireless communications technologies, providing a reliable and low-latency connection for smooth gameplay.

The controller may be equipped with a retention mechanism on its body, which allows it to detachably couple with a mobile device. This mechanism may be a groove or a clip, designed to securely attach the controller to a mobile device case. This feature enhances the portability of the controller, allowing the user to carry their gaming setup in their pocket.

The controller's inputs may include a joystick, which comprises a detectable component operably coupled with a biasing member. The joystick may be designed to provide precise control, with the biasing member returning the joystick to its neutral position when not being manipulated by the user.

The joystick may further comprise at least one sensor opposite the detectable component. This sensor may be operable to capture an input to the joystick from a user, translating the user's movements into in-game actions. The sensor may be a Hall effect sensor, a potentiometer, or any other type of sensor suitable for capturing joystick inputs.

The biasing member in the joystick may comprise a spiral spring, which may provide a smooth and responsive feel to the joystick. The spiral spring may bias the joystick to a neutral position when not being manipulated, providing consistent control during gameplay.

The detectable component in the joystick may comprise a magnet, which may be suspended within the spiral spring. The magnet may interact with the sensor in the joystick, which may allow the controller to detect the position of the joystick and translate it into in-game actions.

The controller's inputs may further include at least one button, at least one trigger, at least one directional pad, and at least one touch surface. These inputs may provide a variety of ways for the user to interact with the game, offering a versatile gaming experience.

The wireless communications module in the controller may comprise Bluetooth. This technology may provide a reliable and low-latency connection between the controller and the gaming system, ensuring smooth and responsive gameplay.

The body of the controller may comprise a uniform thickness, contributing to its compact and portable design. Despite its small size, the controller may be designed to be comfortable to hold and use, providing an enjoyable gaming experience.

The body of the controller may further comprise a thickness of less than 1.0 centimeter. This slim design allows the controller to easily fit within a user's pocket, enhancing its portability. Despite its slim profile, the controller does not compromise on functionality, offering a full suite of inputs and features.

In some aspects, the systems and techniques may include a portable game controller system, which may comprise a mobile device having a game-controller retainer, such as a retention mechanism comprising a groove, which may be integrated with a mobile device case. This system also may comprise a game controller with a retainer, such as a retaining mechanism, about a portion of its perimeter, such as a tongue. The retaining mechanism may be designed to fit within the device retaining mechanism, allowing the controller to detachably couple with the mobile device.

The retention mechanism on the controller may comprise at least one groove. This groove may allow the controller to securely attach to a mobile device case, preventing the controller from accidentally detaching when stowed or stored, or during gameplay. The groove may be designed to be compatible with a variety of mobile device cases, offering a universal solution for mobile gaming.

The mobile device in the portable game controller system may comprise a mobile device case. The game-controller retention mechanism may be coupled with this case, providing a secure and convenient way to attach the controller to the mobile device.

The game-controller retention mechanism may comprise at least one tongue. The retaining mechanism on the controller may comprise at least one corresponding groove. This design ensures a secure attachment between the controller and the mobile device, preventing accidental detachment when stowed or stored, or during gameplay.

In some aspects, the systems and techniques may also include a mobile device case, which may comprise a sleeve operable to fit about a mobile device. The sleeve may comprise a game-controller retention mechanism, which may be designed to fit about a portable game controller. This design may allow the user to securely attach their game controller to their mobile device, providing a convenient and portable gaming solution.

The game-controller retention mechanism on the mobile device case may comprise at least one tongue. This tongue may be designed to fit with a corresponding groove on an external game controller, ensuring a secure attachment between the controller and the mobile device.

The portable video game controller may comprise a body with a front cover and a back cover. Inside this body may be a circuit board, which may be responsible for processing inputs from the controller. The controller may further comprise at least one input, which may be a joystick. This joystick may comprise a detectable component operably coupled with a biasing member.

The biasing member in the joystick may be a spiral spring. The spiral spring may provide a smooth and responsive feel to the joystick, ensuring accurate control during gameplay. The spring may be designed to return the joystick to its neutral position when not being manipulated, providing consistent control.

The detectable component in the joystick may be a magnet, which may be suspended within the spiral spring. The magnet may interact with the sensor in the joystick, allowing the controller to detect the position of the joystick and translate it into in-game actions.

The joystick may further comprise at least one sensor opposite the detectable component. This sensor may be operable to capture an input to the joystick from a user, translating the user's movements into in-game actions. The sensor may be a Hall effect sensor, an optical sensor, or any other type of sensor suitable for capturing joystick inputs.

In some aspects, the systems and techniques may include compact and portable video game controller that can detachably couple to a user's external mobile device case, or in some embodiments, to a user's phone. The controller may be equipped with a variety of inputs and features, offering a versatile and enjoyable gaming experience. The controller's compact design may allow it to fit within a user's pocket, making it an ideal solution for mobile gaming.

In particular, FIG. 1 illustrates a front view of a portable video game controller 100, which may be designed to be compact enough to fit within a user's pocket. The portable video game controller 100 may comprise a body 110. The body 110 may comprise a front cover 112. The body 110 may further comprise a back cover 114. The front cover and the back cover may be operable to be couple to one another and to house various components of the portable video game controller 100, as contemplated herein. The portable video game controller 100 may comprise a circuit board housed within the body, as discussed herein below. The portable video game controller 100 may further comprise various user input receivers, each of which may be operably coupled with the circuit board. The portable video game controller 100 may also comprise a power supply, a wireless charging module, a wireless communications module, and a retention mechanism, as discussed below.

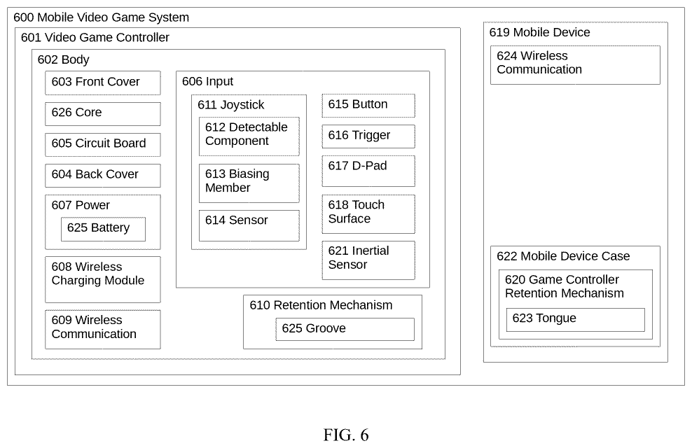

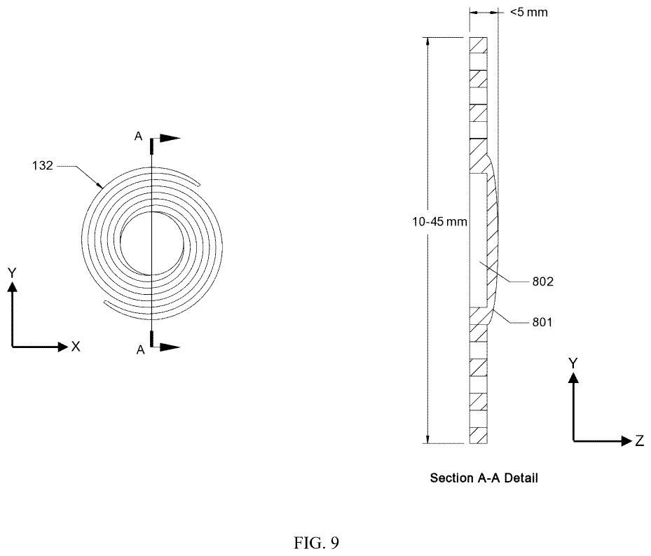

The portable video game controller 100 may comprise a joystick 130. The joystick 130 may be operably coupled with the circuit board. Referring briefly to FIG. 6, FIG. 8, and FIG. 9, the joystick 130 may comprise a biasing member 132. The biasing member 132 may comprise a spring, such as for example, a planar spiral spring. The biasing member 132 may be operably coupled with a detectable component 134. The detectable component 134 may be sized to fit within the biasing member 132. In some embodiments, the detectable component 134 may be suspended within recess 802 of biasing member 132. The detectable component 134 may be positioned in or approximately at the center of the biasing member 132. Some embodiments may include wherein the detectable component 134 may comprise a magnet. In some embodiments, the joystick 130 also may comprise sensor 136 opposite the detectable component 134. The sensor 136 may capture a user's input to the joystick 130 and communicate such input to the circuit board. In some embodiments, multiple sensors may be used.

In some embodiments, the portable game controller 100 may comprise a directional pad 140. The directional pad 140 may be operable to receive an input from a user.

In some embodiments, the portable game controller 100 may comprise a first trigger 150. In some embodiments, the portable game controller 100 may comprise a second trigger 152. Each of the first trigger 150 and the second trigger 152 may be operably coupled with the circuit board and may be operable to communicate inputs from a user to the circuit board.

In some embodiments, the portable game controller 100 may comprise a Start button 160. In some embodiments, the portable game controller 100 may comprise a Select button 164. Each of the Start button 160 and the Select button 164 may be operably coupled with the circuit board and may be operable to communicate inputs from a user to the circuit board.

In some embodiments, the portable game controller 100 may comprise a first playing button 170, a second playing button 172, a third playing button 174, and a fourth playing button 176. Each of the first playing button 170, the second playing button 172, the third playing button 174, and the fourth playing button 176 may be operably coupled with the circuit board and may be operable to communicate inputs from a user to the circuit board.

In some embodiments, the portable game controller 100 may comprise a touch surface 182. The touch surface 182 may provide an alternative to the joystick.

In some embodiments, the portable game controller 100 may comprise a wireless transceiver, represented by 184. The wireless transceiver may be couple to the circuit board, and may be operable to send and receive information, data, and signals to and from an external source, such as, for example a mobile device.

In some embodiments, the portable game controller 100 may comprise a power supply 180. The power supply 180 may comprise a battery, such as a rechargeable battery. The power supply 180 of the controller may be responsible for providing the energy for the controller's operations. This power supply 180 may be coupled with a wireless charging module, which allows the controller to be charged wirelessly, enhancing the convenience and portability of the controller.

In some embodiments, the portable game controller 100 may comprise a charging interface, represented by 181. The charging interface may comprise a wired charging interface, a wireless charging interface, or both. The charging interface may conduct power to the power supply 180 in order to recharge the power supply 180.

The power supply 180 of the controller may be responsible for providing the energy for the controller's operations. This power supply 180 may be coupled with a wireless charging module, which allows the controller to be charged wirelessly, enhancing the convenience and portability of the controller.

In some embodiments, the portable game controller 100 may comprise an indicator light 192, which may be operable to indicate the status of the device. Indicator light 192 may be protected by, and visible through, a top lens 316.

The body 110 of game controller 100, may be designed with a uniform thickness, preferably less than 1.0 centimeter. Such a slim profile may allow the game controller 100 to be conveniently portable and mobile, allowing a user to carry the controller easily on one's person.

The body 110 also may comprise a retention mechanism 190, which can detachably couple with an exterior case, as discussed below. The retention mechanism 190 may be positioned on the external perimeter of the body 110. In some embodiments, the retention mechanism 190 may comprise at least one groove. In some embodiments, the retention mechanism 190 may comprise a groove over a portion of the perimeter of the body 110. In some embodiments, the retention mechanism may extend about the full perimeter of the body 110.

Some embodiments may include wherein the retention mechanism may comprise a friction grip or a press fit.

Some embodiments may include wherein the retention mechanism may include magnets in the game controller 100, such that the magnets hold the game controller 100 within the mobile device case.

The body 110 of game controller 100 may house a circuit board. The circuit board may be the main hub of the operations of game controller 100. and it may be coupled with at least one controller input and a power supply. The controller input may include a joystick, buttons, triggers, a directional pad, and a touch surface 182, which may provide a comprehensive control interface for the user.

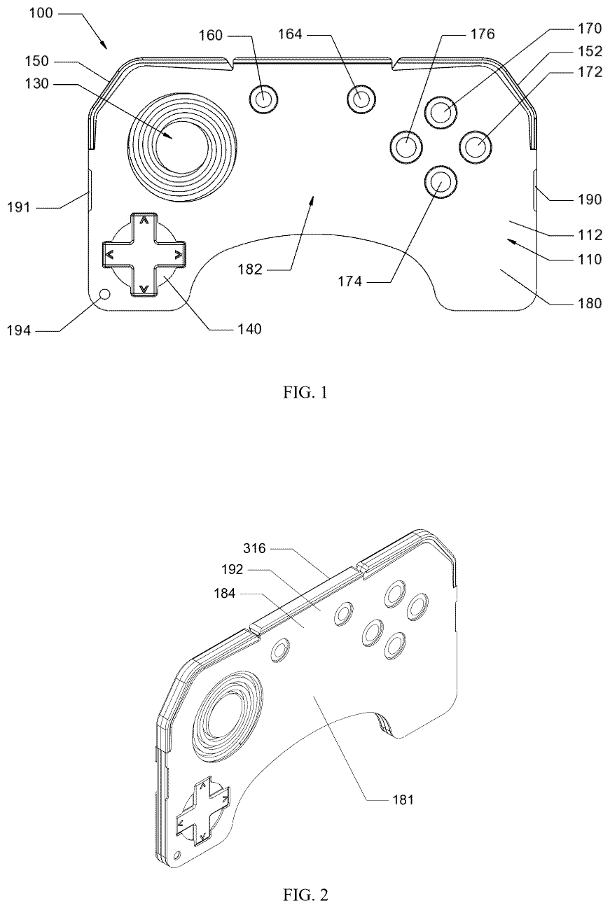

Referring to FIG. 2, a perspective view of the portable video game controller 100 may be shown. The portable video game controller 100 may be compact and designed to fit within a user's pocket. It can be detachably coupled to a user's mobile device case, making it highly portable and convenient for on-the-go gaming. The controller may be operable to connect to a gaming system via a wireless connection, allowing for seamless gameplay without the need for physical connections.

The portable video game controller 100 may comprise a body 110 that may comprise a front cover and a back cover, as previously discussed. This body 110 may house a circuit board, as previously discussed, which may be the main component that drives the functionality of the controller. The circuit board may be coupled with at least one controller input, a power supply, a wireless charging module, and a wireless communications module.

The controller input may be an integral part of the portable video game controller 100 as it allows the user to interact with the gaming system. This input may include a joystick, buttons, triggers, a directional pad, and a touch surface. The joystick comprises a detectable component operably coupled with a biasing member, such as a planar spiral spring. This detectable component may be a magnet suspended within the spiral spring.

The joystick may further comprise at least one sensor opposite the detectable component. This sensor may be operable to capture an input to the joystick from a user, allowing the user to control the gaming system. The use of a magnet and sensor in the joystick allows for precise control, enhancing the user's gaming experience.

The power supply of the video game controller may be coupled with the circuit board, providing the power for the controller to function. A wireless charging module may be coupled to the power supply, allowing the controller to be charged wirelessly. This feature adds to the portability and convenience of the controller.

The wireless communications module may be coupled with the circuit board. This module may be operable to communicate with an external electronic device, such as a gaming system or a mobile device. The wireless communications module may utilize Bluetooth or near-field communication technologies to establish a connection with the external device.

The body of the portable video game controller 100 also may comprise a retention mechanism that may be operable to detachably couple with a mobile device. This mechanism may comprise at least one groove. The design of the body may be such that it has a uniform thickness, which may be below 1.0 centimeter, contributing to the compactness of the controller.

The portable video game controller 100 system may also include a mobile device with a game-controller retention mechanism. This mechanism may be designed to fit a retaining mechanism around at least a portion of the perimeter of the game controller. The retaining mechanism may be operable to detachably couple with the game-controller retention mechanism, allowing the controller to be securely attached to the mobile device.

In conclusion, the portable video game controller 100 provides a compact, portable, and convenient solution for mobile gaming. Its ability to detachably couple with a mobile device and connect wirelessly to a gaming system enhances the user's gaming experience. The design and functionality of the controller, as described above, make it a versatile and user-friendly device for gaming enthusiasts.

Referring to FIG. 5, an illustration of an exploded view of a video game controller is shown. The controller may be designed to be sufficiently small to fit within a user's pocket and can be detachably coupled to a user's mobile device case. The controller may be also operable to connect to a gaming system via a wireless connection.

The portable video game controller 100 may comprise a body, which may comprise a back cover 114, a front cover 112, and a core 314. The game controller 100 may comprise various other components. Some embodiments may include wherein the game controller 100 comprises a front cover adhesive layer 320. Some embodiments may include wherein the game controller 100 comprises a directional pad opening 141. Some embodiments may include wherein the game controller 100 comprises a back cover adhesive layer 300. Some embodiments may include wherein the game controller 100 comprises a rear spacer 304. Some embodiments may include wherein the game controller 100 comprises a rear spacer adhesive 308. Some embodiments may include wherein the game controller 100 comprises a top lens 316. Some embodiments may include wherein the game controller 100 comprises a circuit assembly 310 and a circuit board adhesive 312. The circuit assembly 310 may be the central component of game controller 100, facilitating the operation of the controller's various functions and features. It may be coupled with at least one controller input, such as any of the inputs described here. The circuit board may be further coupled with a power supply, such as a battery 313, within the body 110. The controller input may comprise a joystick, buttons, triggers, a directional pad, or a touch surface, providing a range of control options for the user.

In addition to the controller input, the circuit assembly 310 may include a wireless charging module and a wireless communications module housed within, or exterior to, the body 110. The wireless charging module may be coupled to the power supply, allowing the controller to be charged wirelessly. The wireless communications module enables the controller to communicate with an external electronic device such as a gaming console or a mobile device. The communications module may use technologies such as Bluetooth.

As discussed herein, the controller also features a retention mechanism on the body, which allows it to be detachably coupled with a mobile device. This mechanism may include at least one groove that fits with a corresponding component on the mobile device or its case. This feature allows the controller to be securely attached to the mobile device when in use and easily detached when not needed.

The joystick of the controller may comprise a detectable component 134 operably coupled with a biasing member 132. The detectable component may be a magnet, which may be suspended within the biasing member, such as a planar spiral spring. This arrangement allows the joystick to return to its neutral position when not being manipulated by the user. The joystick also may comprise at least one sensor opposite the detectable component, which captures an input to the joystick from a user.

The body of the controller may be designed to be compact, with a uniform thickness. In some embodiments, the thickness of the body may be below 10 millimeters. This slim profile allows the controller to be easily carried in a user's pocket, enhancing its portability.

In addition to the video game controller, the systems and techniques also may include a mobile device case that may be operable to attach to the controller. The mobile device case may comprise a sleeve that fits about a mobile device. This sleeve may comprise a game-controller retention mechanism, which can fit about the controller. This allows the controller to be securely attached to the mobile device case when in use and easily detached when not needed. The game-controller retention mechanism may include at least one tongue that fits with a corresponding groove on the controller, ensuring a secure fit.

In summary, FIG. 5 provides an exploded view of a compact and portable video game controller that can be detachably coupled to a user's mobile device case. The controller may comprise a body housing, a circuit board, a wireless charging module, a wireless communications module, and a retention mechanism. It also features a joystick with a biased detectable component and a sensor for capturing user inputs. The controller can be used with a mobile device case that may comprise a game-controller retention mechanism for secure attachment.

Referring now to FIG. 6, which may be a block diagram illustrating the use of a portable video game controller system 600. The system may comprise a portable video game controller 601 and a mobile device 619. The portable video game controller 601 may comprise of a body 602, a circuit board 605, at least one controller input 606, a power supply 607, a wireless charging module 608, and a wireless communications module 609. The body 602 also may comprise a retention mechanism 610 that may be operable to detachably couple with the mobile device 619. The mobile device 619 may be equipped with a game-controller retention mechanism 620.

The body 602 of the portable video game controller 601 may be comprised of a front cover 603, a back cover 604, and a core 626. The body 602 may be designed with a uniform thickness, which may be below 10 millimeters. This design allows the portable video game controller 601 to have a profile sufficiently small to fit within a user's pocket, making it portable and convenient for the user.

The circuit board 605 may be housed within the body 602 and may be coupled with the controller input 606, the power supply 607, the wireless charging module 608, and the wireless communications module 609. The circuit board 605 serves as the main operational unit of the portable video game controller 601, controlling the various functions and operations of the controller.

The controller input 606 may be coupled with the circuit board 605 and may comprise a joystick 611. The joystick 611 may comprise a detectable component 612 that may be operably coupled with a biasing member 613. The detectable component 612 may be a magnet that may be suspended within the biasing member 613. The biasing member 613 may comprise a spiral spring, The joystick 611 also may comprise at least one sensor 614 opposite the detectable component 612, which may be operable to capture an input to the joystick from a user.

The controller input 606 further may comprise at least one button 615, at least one trigger 616, at least one directional pad 617, and at least one touch surface 618. The controller input 606 may comprise at least one inertial sensor 621. These components provide various input options to the user, enhancing the gaming experience.

The power supply 607 may be coupled with the circuit board 605 and provides the power for the operation of the portable video game controller 601. The wireless charging module 608 may be coupled to the power supply 607, allowing the portable video game controller 601 to be charged wirelessly, providing convenience to the user.

The wireless communications module 609 may be coupled with the circuit board 605 and may be operable to communicate with an external electronic device. The wireless communications module 609 can comprise Bluetooth technology, enabling the portable video game controller 601 to connect to a gaming system via a wireless connection.

The retention mechanism 610 on the body 602 may be operable to detachably couple with the mobile device 619. The retention mechanism 610 may comprise at least one groove 625, allowing for the secure attachment of the portable video game controller 601 to the mobile device 619.

The mobile device 619 may comprise a game-controller retention mechanism 620. The portable video game controller 601 has a retention mechanism 610 that fits within the game-controller retention mechanism 620 and may be operable to detachably couple with the game-controller retention mechanism 620. This allows the portable video game controller 601 to be securely attached to the mobile device 619, providing a stable gaming platform for the user.

The mobile device 619 may comprise a mobile device case 622, wherein the game-controller retention mechanism 620 may be coupled with the mobile device case 622. This design may allow the game-controller retention mechanism 620 to be securely attached to the mobile device case 622, providing a secure and stable platform for the portable video game controller 601.

The game-controller retention mechanism 620 may comprise at least one tongue 623 allowing for a secure and stable attachment between the portable video game controller 601 and the mobile device 619.

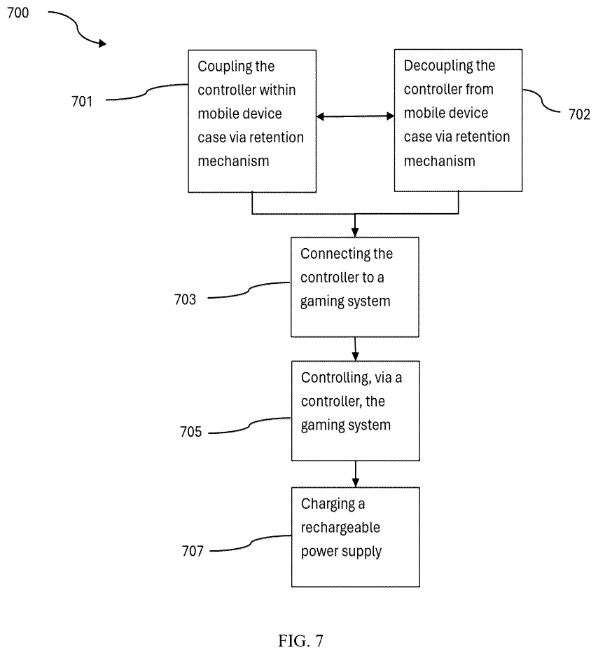

FIG. 7 illustrates a method for portable gaming, which may comprise the steps of attaching a video game controller to a mobile device case, connecting the controller to a gaming system, and controlling the gaming system using the controller. This method may be facilitated by a video game controller having a profile sufficiently small to fit within a user's pocket and operable to detachably couple to a user's mobile device case. The mobile device case may be operable to attach to the controller, and the video game controller may be operable to connect to a gaming system via a wireless connection.

In the step 701, the video game controller may be attached to the mobile device case. This may be facilitated by a retention mechanism on the body of the controller, which may be operable to detachably couple with a mobile device. The controller body may comprise a front cover and a back cover, housing a circuit board within. The retention mechanism may comprise at least one groove, enabling it to securely attach to the mobile device case.

The mobile device case itself may be designed to fit about a mobile device, comprising a game-controller retention mechanism coupled with the sleeve. This game-controller retention mechanism may be operable to fit about the portable game controller, facilitating the attachment of the controller to the mobile device case. The game-controller retention mechanism may comprise at least one tongue, designed to fit with a corresponding groove on the external game controller.

In parallel step 702, the video game controller may be decoupled or detached from the mobile device case. This may be facilitated by applying a force to detach the retention mechanism on the body of the controller from the retention mechanism on the mobile device case.

The portable game controller may be connected to the gaming system when the portable game controller is coupled with the mobile device case or when it is detached from the mobile device case, as shown in step 705. This may be achieved through a wireless communications module coupled with the circuit board of the controller. The wireless communications module may be operable to communicate with an external electronic device, such as a gaming system. The wireless communications module may comprise Bluetooth technology, enabling seamless connection to the gaming system.

The method may further involve step 707, controlling the gaming system using the controller. The controller may comprise at least one input coupled with the circuit board, which may include a joystick, buttons, triggers, a directional pad, and a touch surface. The joystick may comprise a detectable component operably coupled with a biasing member, such as a planar spiral spring. The detectable component, which may be a magnet, may be suspended within the spiral spring. The joystick further may comprise at least one sensor opposite the detectable component, which may be operable to capture an input to the joystick from a user. This allows the user to control the gaming system through the controller, completing the method for portable gaming as illustrated in FIG. 7.

Some embodiments may include charging a rechargeable power supply of the portable game controller, as shown in step 709.

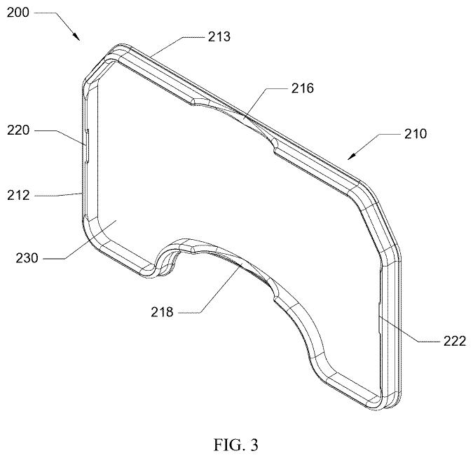

Referring to FIG. 3, a perspective view of a game controller retainer 200 is illustrated. The game controller retainer 200 may comprise a body 210. The body 210 may comprise a wall 212. The game controller retainer may be adhered to a mobile device or mobile device case by using adhesive backing 213.

The game controller retainer 200 may be operable to couple with a portable game controller 100. The game controller retainer 200 may securely hold the game controller 100 and may be equipped with a retention feature, such as retainer tabs 220 and 222, which detachably couple with the portable game controller 100.

The design of the game controller retainer 200 may allow for seamless integration between a mobile device and the game controller 100. Such a design may provide an enhanced gaming experience for the user and may make the experience more convenient and accessible to the user.

Some embodiments may include wherein retainer tab 220 and retainer tab 222 extend over the full perimeter of the body 210 of the game controller retainer 200. Some embodiments may include wherein retainer tab 220 and retainer tab 222 extend over a partial portion of the perimeter or as depicted in FIG. 3, wherein retainer tab 220 and retainer tab 222 extend over a limited portion of the perimeter.

Some embodiments may include wherein the retention feature of the game controller retainer 200 and the retention feature of the game controller 100 may comprise a friction grip or a press fit. Some embodiments may include wherein the retention feature includes magnets in the game controller 100 and in the game controller retainer 200, such that the magnets hold the game controller 100 within the game controller retainer 200.

Some embodiments may include wherein the game controller retainer 200 comprises an entrapment device. Such an entrapment device may comprise a captive recess in the game controller retainer 200 that receives the game controller 100. In order to insert or remove the game controller 100, the game controller retainer must first be opened. The game controller 100 may be locked into place by closing the game controller retainer 200.

Some embodiments may include wherein the game controller 100 may be coupled with the game controller retainer 200 such that the inputs are adjacent to an inner surface 230 of the game controller retainer. Some embodiments may include wherein the game controller 100 may be coupled with the game controller retainer 200 such that the side of the game controller opposite the inputs is adjacent to the inner surface 230 of the game controller retainer. Some embodiments may include wherein both configurations are possible.

Some embodiments may include wherein the body 210 of the game controller retainer 200 may comprise a cutout 216 from the wall 212. The cutout 216 may be leveraged by a user to release the game controller 100 from the game controller retainer 200. Some embodiments may include wherein the body 210 may comprise a second cutout 218 on the wall 212. A second cutout 218 may, in some embodiments, be positioned opposite the cutout 216.

The game controller retainer 200, as shown in FIG. 3, may be a protective sleeve designed to fit snugly around a mobile device. The sleeve may be made from a durable material that may be capable of withstanding impact and everyday wear and tear. The game controller retainer 200 may comprise openings in the appropriate places to allow access to the mobile device's buttons, ports, and camera.

The game-controller retention mechanism may be designed to fit around a portable game controller 100. The game controller retention mechanism may be designed with at least one tongue that may be operable to fit with a corresponding groove on the game controller 100. This design ensures a secure and stable connection between the game controller retainer and the game controller.

The coupling mechanism between the game controller retainer and the game controller may be designed to be easily detachable. This allows the user to quickly and conveniently attach and detach the game controller as needed, providing flexibility in the use of the mobile device and the game controller.

The game controller retainer 200 also may comprise a wireless charging module. This module may be designed to draw power from a power supply and wirelessly charge the mobile device when it may be housed within the game controller retainer. This feature provides added convenience for the user, as it eliminates the need for charging cables.

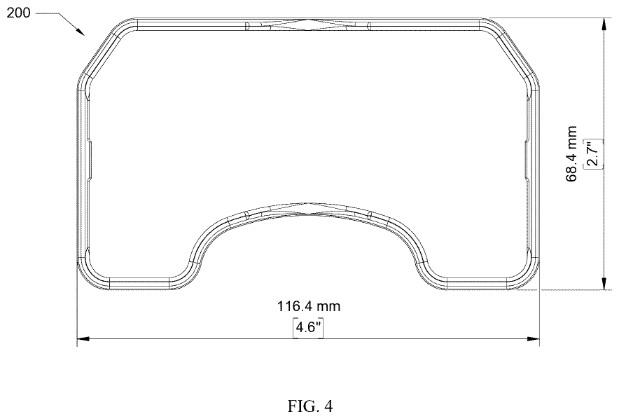

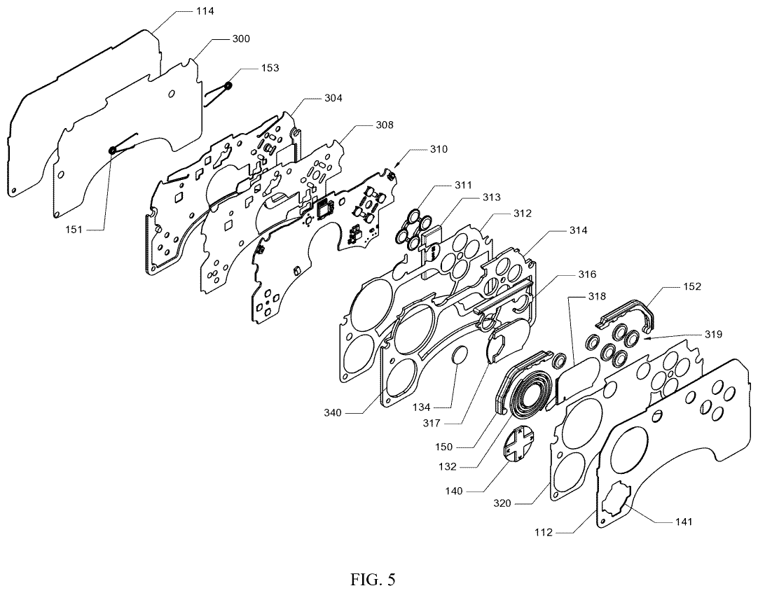

Referring now to FIG. 4, a front view of a game controller retainer 200 operable to couple with a portable video game controller is illustrated. The game controller retainer may be designed to attach to a mobile device and may comprise a game-controller retention mechanism. This game-controller retention mechanism may be operable to fit about a portable game controller 100, enabling the mobile device to be used in conjunction with the video game controller.

In conclusion, FIGS. 3 & 4 illustrate a game controller retainer with a unique design that allows it to couple with a portable video game controller. Its features, including the game-controller retention mechanism and the wireless charging module, provide an enhanced gaming experience for the user. The game controller retainer may be designed to be durable, convenient, and flexible, catering to the needs of mobile gamers.

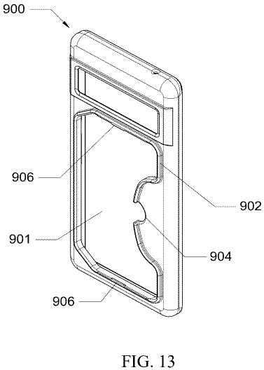

Referring to FIG. 13, in some embodiments, the mobile device may include a mobile device case 900 with a game-controller retention mechanism integrated into it. Game controller 100 is fit into recess 901. Protective rim 902 circumscribes the game controller 100, helping ensure that game controller 100 is not damaged when stowed. The game-controller retention mechanism may comprise at least one tongue 906, and the retaining mechanism on game controller 100 may comprise at least one corresponding groove (e.g., retention mechanism 190), facilitating a secure connection between the controller and the mobile device. Removal of the game controller 100 may be facilitated through the inclusion of finger recess 904.

In summary, FIG. 13 illustrates a streamlined storage mechanism for a game controller that presents a highly portable and convenient form factor, enhancing the portable gaming experience for the user.

FIG. 8 and FIG. 9 illustrate an example planar spiral spring which may be an example of biasing member 132. The spiral spring illustrated in FIG. 8 and FIG. 9 is a multi-start spiral spring, possessing multiple splines, including spline 810 and spline 811. Because the example spring shown has two splines, biasing member 132 may be referred to as a two-start spiral spring.

Biasing member 132 may be referred to as “flat” and/or “planar” because biasing member 132 may be wound in an XY plane around a winding axis that extends orthogonal to the XY plane (e.g., in a direction parallel to the Z axis). In some aspects, biasing member 132 may have a thickness (e.g., in the Z direction) of 5 millimeter (mm) or less. Biasing member 132 may be referred to as “flat” and “planar” based on the windings being substantially within a plane regardless the thickness of biasing member 132.

Biasing member 132 may have a cross section of any suitable shape, for example, as illustrated in FIG. 9, biasing member 132 may have square cross section. In other aspects, biasing member 132 may have a circular, elliptical, or rectangular cross section. Biasing member 132 may be referred to as “flat” and “planar” based on the windings being substantially within a plane regardless the shape of the cross section of biasing member 132.

In the middle of the spiral spring is central body 801. For example, an innermost winding of splines (and/or a termination of the innermost winding) of biasing member 132 may be coupled to central body 801. The front side of the central body 801 may be domed or shaped to form a pad, providing tactile sensation to a user as the spiral spring is actuated laterally by the user. The back side of central body 801 possesses a recess 802 for receiving a detectable component (e.g., detectable component 134). The biasing member 132, central body 801, and the pad may have a thickness of 5 mm (e.g., in the Z direction) or less.

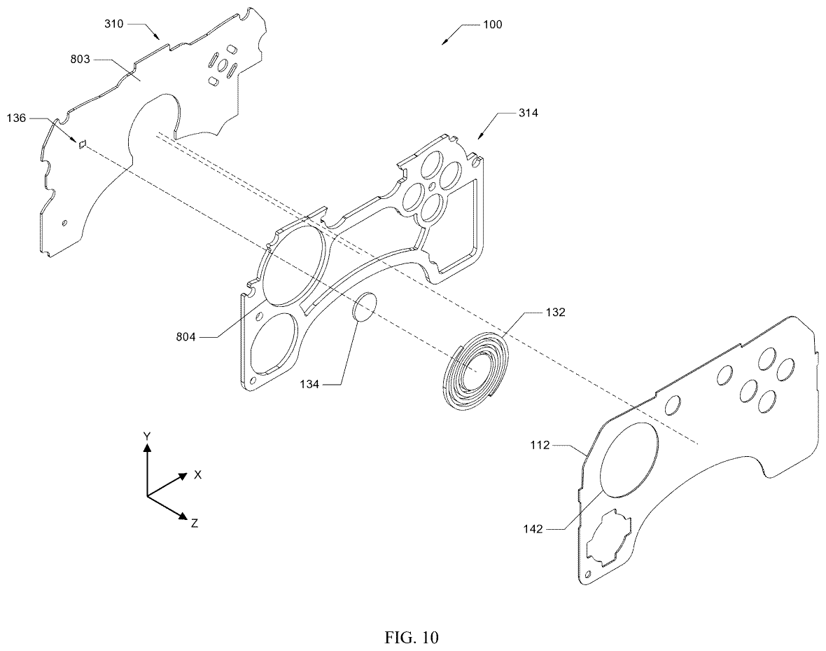

FIG. 10 illustrates an exploded perspective view of portions of game controller 100, including front cover 112, biasing member 132, detectable component 134, core 314, and circuit assembly 310. Core 314 may be adhered to circuit assembly 310. Detectable component 134 is inserted into recess 802 in biasing member 132. The biasing member 132 is set into core 314 utilizing biasing-member recess 804, allowing detectable component 134 to slide across or above the surface of circuit board 803. Biasing member 132 is held into biasing-member recess 804 by the front cover 112.

Sensor 136 may be included in, on a front surface of (e.g. the surface visible in FIG. 10), or on a back of circuit assembly 310. Sensor 136 is illustrated in FIG. 10 using dashed lines to indicate that sensor 136 is on a back surface of circuit assembly 310 in the illustrated aspect. In other aspects, sensor 136 may be included in (e.g., between layers of) circuit assembly 310. In other aspects, sensor 136 may be on a front surface of circuit assembly 310.

Sensor 136 is sized and positioned to sense a position (e.g., a lateral position) of detectable component 134. Game controller 100 may be configured to interpret the position of detectable component 134, as detected by sensor 136, as an input and generate a signal (e.g., a control signal) based on the position of detectable component 134. Game controller 100 may be configured to interpret the position of detectable component 134 when biasing member 132 is in a neutral position as no input. Game controller 100 may be configured to interpret lateral movements of detectable component 134 away from a neutral position of biasing member 132 as directional inputs.

In some aspects, biasing member 132 is not permanently connected to core 314, circuit board 803, or to any other portion of the controller. For example, biasing member 132 may be replaceable in game controller 100. For example, biasing member 132 may be retained (e.g., in a Z direction) between circuit board 803, and front cover 112. Additionally, biasing member 132 may be retained in an X and Y direction by biasing-member recess 804 of core 314. Yet, within biasing-member recess 804, biasing member 132 may rotate (e.g., about an axis of a winding of biasing member 132, such as about an axis in the z direction). Stated another way, biasing member 132 may rotate about an axis orthogonal to the translational plane (e.g., the XY plane).

Biasing-member recess 804 and biasing member 132 may be sized such that an outermost winding of biasing member 132 may not move laterally (or move only slightly) within biasing-member recess 804. For example, a diameter of biasing-member recess 804 may be substantially the same as, or slightly smaller than, an outer diameter of biasing member 132 when biasing member 132 is not within biasing-member recess 804.

Biasing member 132 may be deformed as central body 801 is moved away from a neutral position (e.g., a neutral position of biasing member 132). For example, portions of biasing member 132 may be compressed and other portions of biasing member 132 may be stretched as central body 801 is moved away from a central position. Biasing member 132 may bias central body 801 to the central position.

Because biasing member 132 is free to rotate within biasing-member recess 804 (e.g., around an axis in the Z direction), biasing member 132 is not stretched and/or compressed as a user rotates the joystick. Not stretching or compressing biasing member biasing member 132 when biasing member 132 rotates, may prevent wear and tear on biasing member 132 that results from deforming biasing member 132 rotationally.

Sensor 136 may sense a position of detectable component 134. Sensor 136 may, or may not, sense an orientation of detectable component 134. For example, game controller 100 may be configured to track a position of the pad of the joystick and not an orientation of the pad of the joystick.

In some aspects, biasing member 132 may be removed from game controller 100 by an end user, facilitating replacement or customization. For example, an end user may remove front cover 112, remove biasing member 132 from biasing-member recess 804, and replace biasing member 132 with a replacement biasing member. Additionally or alternatively, the end user may compress biasing member 132 and remove biasing member 132 through a hole in front cover 112 (e.g., the hole in front cover 112 through which the end user touches central body 801).

Additionally or alternatively, triggers and/or buttons of the controller may be similarly replaceable. For example, buttons 170, 172, 174, or 176, triggers 150 and 152, and/or directional pad 140 may be replaceable.

The portion of circuit board 803 under detectable component 134 and biasing member 132 may be configured to not be adversely affected by friction of detectable component 134 and biasing member 132. For example, the portion of circuit board 803 under detectable component 134 and biasing member 132 may be coated or covered by a suitable low-friction paint or film.

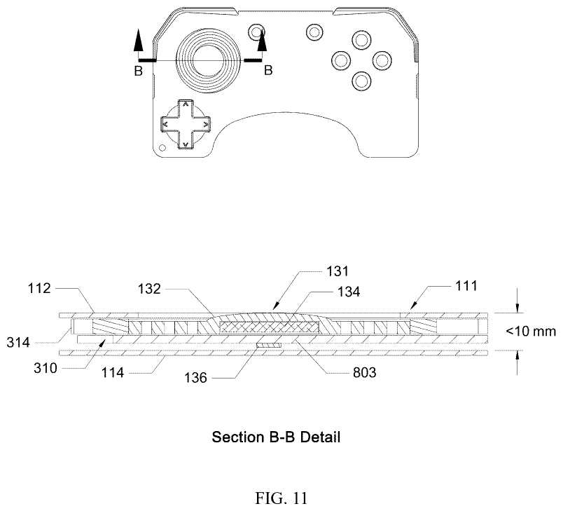

FIG. 11 illustrates the same components as FIG. 10 in a post-assembly configuration. The detail view illustrates sensor 136 positioned on the back side of circuit assembly 310 so as to be able to detect the position of detectable component 134 through circuit board 803.

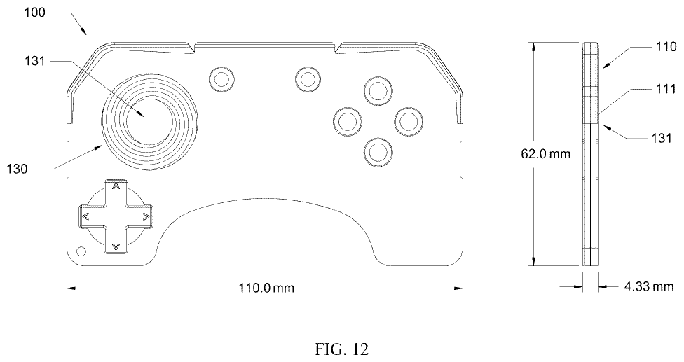

FIG. 12 illustrates the dimensions of one implementation of a controller described by the present disclosure. For example, controller 100 has a uniform thickness of 4.33 millimeters (mm). Additionally, controller 100 has a width of 110.0 mm and a height of 62.0 mm.

The width and height dimensions of controller 100 may be selected such that controller 100 may be held as illustrated in FIG. 14. In this position, the left thumb may be placed on joystick 130 or directional pad 140. In this position, the right thumb may actuate playing buttons 170, 172, 174, or 176. In this position the right thumb may also activate touch surface 182. In this position, the left index finger may actuate first trigger 150. In this position, the right index finger may actuate the second trigger 152.

Additionally or alternatively, the height and width dimensions of controller 100 may be selected such that controller 100 may be the same as, or less than, corresponding dimensions of a computing device, for example, a handheld device, such as a smartphone or a case for a computing device. For example, controller 100 may be sized to fit into recess 901 of mobile device case 900, shown in FIG. 13. Mobile device case 900 may be sized to encompass a handheld device. As such, controller 100 may be sized relative to a handheld device and/or a mobile device case.

Additionally, from the detail view of FIG. 11 and side view of FIG. 12, it can be seen that a topmost surface 131 of joystick 130 does not extend above a topmost surface 111 of body 110 of controller 100. For example, the topmost surface 131 of joystick 130 may be flush with topmost surface 111 of body 110. For example, joystick 130 (including sensor 136, biasing member 132, central body 801, detectable component 134) may have a thickness that is less than a thickness of game controller 100.

In other examples (not illustrated in FIG. 11 or FIG. 12), a topmost surface of a joystick may extend above a topmost surface of a body of a controller. For example, the topmost surface of the joystick may extend 2.5 mm above the topmost surface of the body.

Illustrative aspects of the disclosure include:
Aspect 1. An apparatus for a human-machine interface, the apparatus comprising: a body and a joystick attached to the body, the joystick comprising: a spiral spring configured to bias the joystick to a neutral position; a detectable component coupled to the spiral spring; and a sensor configured to detect a position of the detectable component.
Aspect 2. The apparatus of aspect 1, wherein the joystick comprises a pad to be manipulated by a user, wherein the pad is coupled to the spiral spring.
Aspect 3. The apparatus of any one of aspects 1 or 2, wherein the joystick has a thickness less than 10 millimeters.
Aspect 4. The apparatus of any one of aspects 1 to 3, wherein a topmost surface of the joystick is substantially flush with a topmost surface of the body.
Aspect 5. The apparatus of any one of aspects 1 to 4, wherein a top-most surface of the joystick extends above a topmost surface of the body by 2.5 millimeters or less.
Aspect 6. The apparatus of any one of aspects 1 to 5, wherein the spiral spring is configured to rotate within the body relative to an axis of winding of the spiral spring.
Aspect 7. The apparatus of any one of aspects 1 to 6, wherein the spiral spring comprises a multi-start spiral spring.
Aspect 8. The apparatus of any one of aspects 1 to 7, wherein the spiral spring has a thickness of less than 5 millimeters (mm).
Aspect 9. The apparatus of any one of aspects 1 to 8, wherein the spiral spring has an outer diameter of greater than 10 millimeters (mm) and less than 45 mm.
Aspect 10. The apparatus of any one of aspects 1 to 9, wherein the detectable component comprises a magnet; and the sensor comprises a magnetic field (or Hall effect) sensor.
Aspect 11. The apparatus of any one of aspects 1 to 10, wherein the detectable component comprises a conductive element; and the sensor comprises an inductive or a capacitive sensor.
Aspect 12. The apparatus of any one of aspects 1 to 11, wherein the spiral spring is configured to be replaceable.
Aspect 13. The apparatus of any one of aspects 1 to 12, wherein the body has a substantially uniform thickness.
Aspect 14. The apparatus of any one of aspects 1 to 13, wherein the apparatus has a thickness of 10 millimeters or less.
Aspect 15. The apparatus of any one of aspects 1 to 14, wherein the body is sized to be held in a hand of a user with a thumb on the joystick.
Aspect 16. The apparatus of any one of aspects 1 to 16, wherein the body has a width of 125 millimeters or less and a height of 75 millimeters or less.
Aspect 17. The apparatus of any one of aspects 1 to 17, wherein the body comprises a retention mechanism for attaching the apparatus to a mobile device or to a case of mobile device.
Aspect 18. The apparatus of any one of aspects 1 to 18, wherein the sensor is configured to generate a signal indicative of the position of the detectable component, the apparatus further comprising a wireless communication module configured to send the signal to an external electronic device.
Aspect 19. An apparatus comprising: a mobile-device case comprising a controller-retention mechanism; and a controller comprising a retaining mechanism about at least a portion of a perimeter of the controller, the retaining mechanism operable to fit within the controller-retention mechanism, wherein the retaining mechanism may be operable to detachably couple with the controller-retention mechanism, wherein the controller-retention mechanism comprises a tongue and wherein the retaining mechanism comprises a groove.
Aspect 20. A system comprising: an electronic device; and a controller configured to provide signals to the electronic device; the controller comprising: a body and a joystick attached to the body, the joystick comprising: a spiral spring configured to bias the joystick to a neutral position; a detectable component coupled to the spiral spring; and a sensor configured to detect a position of the detectable component.

### Embodiments

The systems and techniques relate to a portable video game controller, specifically designed for convenience, mobility, and improved gaming experience. The video game controller may be crafted with a compact profile, which fits within a user's pocket, offering high portability and ease of use. This controller can be easily coupled with a user's mobile device case, enabling a seamless gaming experience across different devices.

The video game controller may be composed of a body that houses a circuit board. The body may comprise a front cover, a back cover, and a core, which secures the internal components of the controller. The circuit board contained within the body of the controller may be an integral component. It may be coupled with various interactive elements of the controller, allowing for control inputs to be received, processed, and communicated to the gaming system.

The controller input may be coupled with the circuit board, enabling the user to interact with the gaming system. It may comprise a joystick that adds to the interactive richness of the controller. The joystick contains a detectable component which may be operably coupled with a biasing member. When the joystick may be manipulated by the user, the detectable component moves within the biasing member, providing input to the gaming system.

The power supply for the video game controller may be coupled with the circuit board. It ensures power delivery for the operation of the controller. To enhance convenience, a wireless charging module may be integrated with the power supply. This wireless charging module facilitates the recharge of the controller's power supply, supporting user convenience and uninterrupted gaming sessions.

The portable video game controller 100 also may comprise a wireless communications module. It may be operably connected with the circuit board and may enable the controller to communicate with an external electronic device such as a gaming system. The communication may be facilitated using wireless technologies, providing a seamless and cable-free gaming experience.

Furthermore, the controller features a retention mechanism on its body. This retention mechanism enables the controller to detachably couple with a mobile device. It facilitates a secure attachment, ensuring the controller remains attached during gameplay and can be easily detached when desired.

The gaming controller introduces several innovative features for a comprehensive gaming control interface. These include a joystick operated by a detectable component and a biasing member, which translates user movements into in-game commands, enhancing the gaming experience. The detectable component may be a magnet, which is set within the biasing member, which may be a planar spiral spring. The position of this magnet may be detected and translated into corresponding movements in the game.

The controller may be designed to be highly compatible and universally fit a range of mobile devices. This compatibility may be facilitated by the uniquely-designed retention mechanism composed of at least one groove. This groove couples with corresponding elements on the mobile device or the mobile device case, enabling a secure and sturdy attachment.

The controller input also consists of several other components for diverse gameplay controls, including at least one button, at least one trigger, at least one directional pad, and at least one touch surface. These inputs offer a wide range of controls for different gaming systems, enhancing versatility.

The body of the controller may be designed to be compact with a uniform thickness. This makes it easy to carry and store. This compactness, however, does not compromise the functionality of the controller. Despite its slim profile, the controller offers a comprehensive suite of controls for an immersive gaming experience. These controls may be removable by an end user, facilitating repair and customization.

Another embodiment of the systems and techniques may be, or may include, a portable game controller system. It may comprise a mobile device equipped with a game-controller retention mechanism. The game controller features a retaining mechanism, which fits within the device's retention mechanism. This retaining mechanism can be operated to detachably couple with the game-controller retention mechanism. This configuration provides a stable gaming platform that may be both portable and convenient.

The game-controller retention mechanism can be conveniently designed as an integral part of a mobile device case. This design ensures that the game-controller retention mechanism may be readily available when needed, contributing to the system's convenience and case of use.

Alternative solutions or embodiments may include a mobile device case designed to fit a mobile device. The case features a sleeve and may comprise a game-controller retention mechanism coupled with the sleeve. This game-controller retention mechanism may be operable to fit about a portable game controller, offering a comprehensive gaming solution that combines the mobile device, the mobile device case, and the game controller.

The systems and techniques provide a more efficient and cost-effective solution compared to previous gaming setups. The portable video game controller 100 system eliminates the need for multiple separate components, reducing the overall cost and complexity of the setup. The controller's ability to detachably couple with a mobile device or a mobile device case offers flexibility and convenience, enhancing the gaming experience.

The systems and techniques may be applied in various scenarios where portable gaming solutions are desired. It can be used at home, during travel, or at any location where traditional gaming systems are not readily available or practical. The portable video game controller 100 offers a cost-effective, convenient, and enhanced gaming experience for users.

Some advantages of the systems and techniques include its compact size, high portability, compatibility with various mobile devices, comprehensive control interface, and customizable look & feel. It offers wireless communication with gaming systems, wireless charging, and the convenience of being able to couple with a mobile device or a mobile device case. The portable video game controller 100 provides an efficient and convenient solution for gaming enthusiasts.

The embodiments disclosed herein are intended to be illustrative and not limiting. Other embodiments are possible, and modifications may be made to the embodiments without departing from the spirit and scope of this disclosure. As such, these embodiments are only illustrative of the inventive concepts contained herein.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

The terms “first”, “second”, “third”, etc. are used to distinguish respective elements and are not used to denote a particular order of those elements unless otherwise specified or order is explicitly described or required.

Numerous specific details are set forth to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Embodiments of the methods disclosed may be performed in the operation of such computing devices. The order of the blocks presented in the examples above can be varied—for example, blocks can be re-ordered, combined, and/or broken into sub-blocks. Some blocks or processes may be performed in parallel.

The use of “adapted to” or “configured to” is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, let it be understood that the present disclosure has been presented for purposes of example rather than limitation, and does not preclude inclusion of such modifications, variations and/or additions to the present subject matter as would be readily apparent to one of ordinary skill in the art.

What is claimed is:

1. An apparatus for a human-machine interface, the apparatus comprising:
a body and a joystick attached to the body, the joystick comprising:
a spiral spring configured to bias the joystick to a neutral position;
a detectable component coupled to the spiral spring; and
a sensor configured to detect a position of the detectable component.

2. The apparatus of claim 1, wherein the joystick comprises a pad to be manipulated by a user, wherein the pad is coupled to the spiral spring.

3. The apparatus of claim 1, wherein the joystick has a thickness less than 10 millimeters.

4. The apparatus of claim 1, wherein a topmost surface of the joystick is substantially flush with a topmost surface of the body.

5. The apparatus of claim 1, wherein a top-most surface of the joystick extends above a topmost surface of the body by 2.5 millimeters or less.

6. The apparatus of claim 1, wherein the spiral spring is configured to rotate within the body relative to an axis of winding of the spiral spring.

7. The apparatus of claim 1, wherein the spiral spring comprises a multi-start spiral spring.

8. The apparatus of claim 1, wherein the spiral spring has a thickness of less than 5 millimeters (mm).

9. The apparatus of claim 1, wherein the spiral spring has an outer diameter of greater than 10 millimeters (mm) and less than 45 mm.

10. The apparatus of claim 1, wherein the detectable component comprises a magnet; and the sensor comprises a magnetic field (or Hall effect) sensor.

11. The apparatus of claim 1, wherein the detectable component comprises a conductive element; and the sensor comprises an inductive or a capacitive sensor.

12. The apparatus of claim 1, wherein the spiral spring is configured to be replaceable.

13. The apparatus of claim 1, wherein the body has a substantially uniform thickness.

14. The apparatus of claim 1, wherein the apparatus has a thickness of 10 millimeters or less.

15. The apparatus of claim 1, wherein the body is sized to be held in a hand of a user with a thumb on the joystick.

16. The apparatus of claim 1, wherein the body has a width of 125 millimeters or less and a height of 75 millimeters or less.

17. The apparatus of claim 1, wherein the body comprises a retention mechanism for attaching the apparatus to a mobile device or to a case of mobile device.

18. The apparatus of claim 1, wherein the sensor is configured to generate a signal indicative of the position of the detectable component, the apparatus further comprising a wireless communication module configured to send the signal to an external electronic device.
